(19) United States
(12) Patent Application Publication
(10) Pub. No.: US 2011/0285782 A1
(43) Pub. Date: Nov. 24, 2011

(54) Apparatus for cleaning inkjet print head and inkjet printer having the same

(75) Inventors: Jae Hun Kim, Seoul (KR); Won Chul Sim, Seongnam (KR); Sung Koo Kang, Suwon (KR); Jae Woo Joung, Suwon (KR)

(73) Assignee: SAMSUNG ELECTRO-MECHANICS CO., LTD., Suwon (KR)

(21) Appl. No.: 12/929,611

(22) Filed: Feb. 3, 2011

(30) Foreign Application Priority Data
May 20, 2010 (KR) 10-2010-0047629

(51) Int. Cl. B41J 2/165

(52) U.S. Cl. 347/22

(57) ABSTRACT

There is provided an apparatus for cleaning an inkjet print head and an inkjet printer having the same. The apparatus for cleaning the inkjet print head includes a cleaning plate spaced apart from the inkjet print head with a cleaning area interposed therebetween, the inkjet print head ejecting ink through a nozzle; an electrode part allowing residual ink remaining at an end portion of the nozzle to be moved outwardly of the cleaning plate; and a power supply part electrically connecting the inkjet print head to the electrode part.

### CROSS-REFERENCE TO RELATED APPLICATIONS

This application claims the priority of Korean Patent Application No. 10-2010-0047629 filed on May 20, 2010, in the Korean Intellectual Property Office, the disclosure of which is incorporated herein by reference.

### BACKGROUND OF THE INVENTION

1. Field of the Invention

The present invention relates to an apparatus for cleaning an inkjet print head and an inkjet printer having the same, and more particularly, to an apparatus for cleaning an inkjet print head removing residual ink remaining in a nozzle of the inkjet print head without making contact with the nozzle and an inkjet printer having the same.

2. Description of the Related Art

In general, an inkjet print head is a structure for converting electrical signals into physical force to eject ink in the form of a droplet through a small nozzle. Such an inkjet print head is divided into various types of inkjet print heads according to ink ejection methods. In particular, recently, a piezoelectric inkjet print head that ejects ink using piezoelectrics is widely being used in an industrial inkjet printer.

For example, the piezoelectric inkjet print head is used to directly form a circuit pattern by spraying ink produced by melting a metal such as gold, silver or the like onto a printed circuit board (PCB), create industrial graphics, or manufacture a liquid crystal display (LCD), an organic light emitting diode (OLED), a solar cell, and the like.

In order to achieve high-quality printing, a nozzle of an inkjet print head should be maintained in an optimum state for printing. To this end, generally, a maintenance operation such as purging, wiping, capping or the like is performed. Purging refers to a sort of initialization operation for returning a print head during or after an operation to the state in which it was in before the operation. Wiping refers to wiping out residual ink or debris adhered to the nozzle after purging. Capping refers to separating the nozzle from the exterior.

Among the maintenance operations, wiping is generally performed in a manner such that after a nozzle is subjected to steam spraying or vacuum suction, a wiper in the form of a roller or a blade made of rubber or polymer having elasticity is used to be in contact with the nozzle so as to wipe out residual ink or debris. However, this wiping operation may cause the contamination of the nozzle due to a material used for wiping and particles produced by physical contact with the wiper. In the case in which ink is ejected through the contaminated nozzle, the directional characteristics of ink ejection may be deteriorated.

Also, the wiping operation by the physical contact may damage a water-repellent layer formed around the nozzle in the lower surface of the inkjet print head, thereby causing a wetting problem.

### SUMMARY OF THE INVENTION

An aspect of the present invention provides an apparatus for cleaning an inkjet print head capable of improving ink ejection characteristics by preventing the contamination of a nozzle and the damage to a water-repellent layer through a non-contact method in which residual ink remaining in the nozzle of the inkjet print head is removed without making contact with the nozzle and an inkjet printer having the same

According to an aspect of the present invention, there is provided an apparatus for cleaning an inkjet print head, the apparatus including: an electrode part spaced apart from an inkjet print head with a cleaning area interposed therebetween; and a power supply part electrically connecting the inkjet print head to the electrode part.

The electrode part may include a plurality of electrode cells sequentially disposed therein.

The power supply part may electrically connect the inkjet print head to the plurality of electrode cells in sequential order along a path of residual ink remaining in the inkjet print head.

The electrode part may be disposed outside the cleaning area.

The electrode part may have a water-repellent layer disposed thereon.

The inkjet print head and the electrode part may be electrically connected such that charges of different polarities may be applied to ink of the inkjet print head and the electrode part, respectively.

The inkjet print head may include a piezoelectric actuator providing a driving force for ink ejection, and the power supply part may electrically connect a common electrode of the piezoelectric actuator to the electrode part.

The inkjet print head may have a second electrode disposed around a nozzle, and the power supply part may electrically connect the second electrode to the electrode part.

According to another aspect of the present invention, there is provided an inkjet printer including: an inkjet print head ejecting ink through a nozzle; and a cleaning unit removing residual ink remaining at an end portion of the nozzle of the inkjet print head, wherein the cleaning unit includes: an electrode part spaced apart from the inkjet print head with a cleaning area interposed therebetween; and a power supply part electrically connecting the inkjet print head to the electrode part.

The electrode part may include a plurality of electrode cells sequentially disposed therein.

The power supply part may electrically connect the inkjet print head to the plurality of electrode cells in sequential order along a path of the residual ink.

The electrode part may be disposed outside the cleaning area.

The electrode part may have a water-repellent layer disposed thereon.

The inkjet print head may have a water-repellent layer disposed on a lower surface thereof on which the nozzle is formed.

The inkjet print head and the electrode part may be electrically connected such that charges of different polarities may be applied to the residual ink and the electrode part, respectively.

The inkjet print head may include a piezoelectric actuator providing a driving force for ink ejection, and the power supply part may electrically connect a common electrode of the piezoelectric actuator to the electrode part.

The inkjet print head may have a second electrode disposed around the nozzle, and the power supply part may electrically connect the second electrode to the electrode part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an inkjet printer having an apparatus for cleaning an inkjet print head according to a first exemplary embodiment of the present invention;

FIGS. 2A and 2B are views illustrating a cleaning principle according to an exemplary embodiment of the present invention;

FIGS. 3A through 3F are views illustrating a method of cleaning the inkjet print head in the inkjet printer according to the first exemplary embodiment of the present invention;

FIG. 4 is a schematic cross-sectional view illustrating an inkjet printer having an apparatus for cleaning an inkjet print head according to a second exemplary embodiment of the present invention;

FIG. 5 is a view illustrating the movement of ink during cleaning in the inkjet printer according to the second exemplary embodiment of the present invention; and

FIG. 6 is a schematic cross-sectional view illustrating an inkjet printer having an apparatus for cleaning an inkjet print head according to a third exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

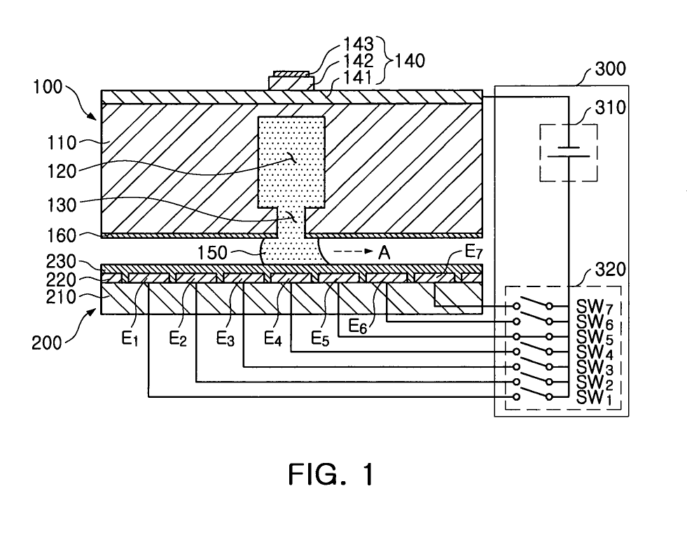

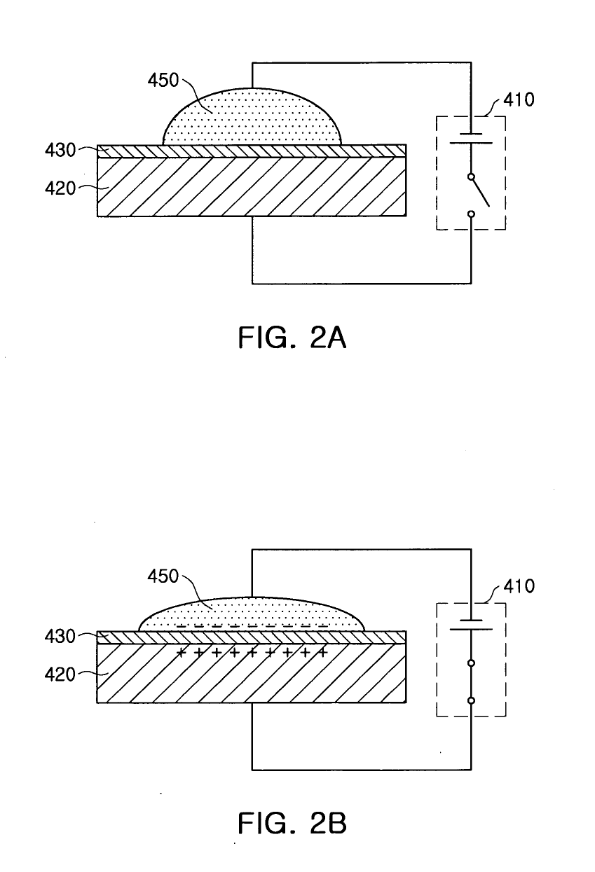

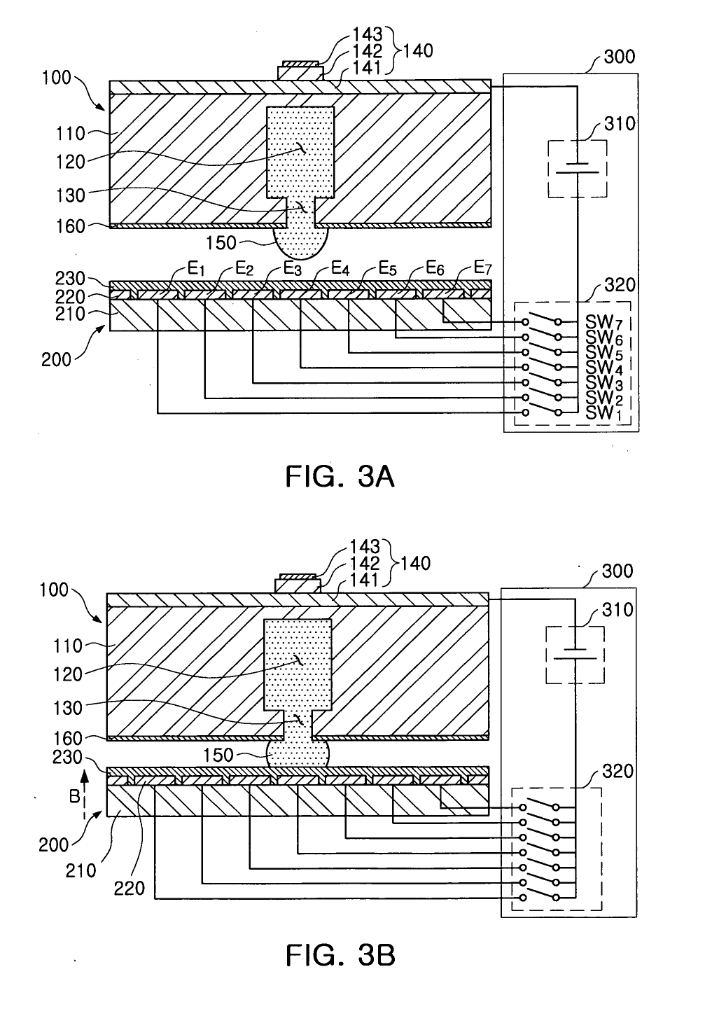

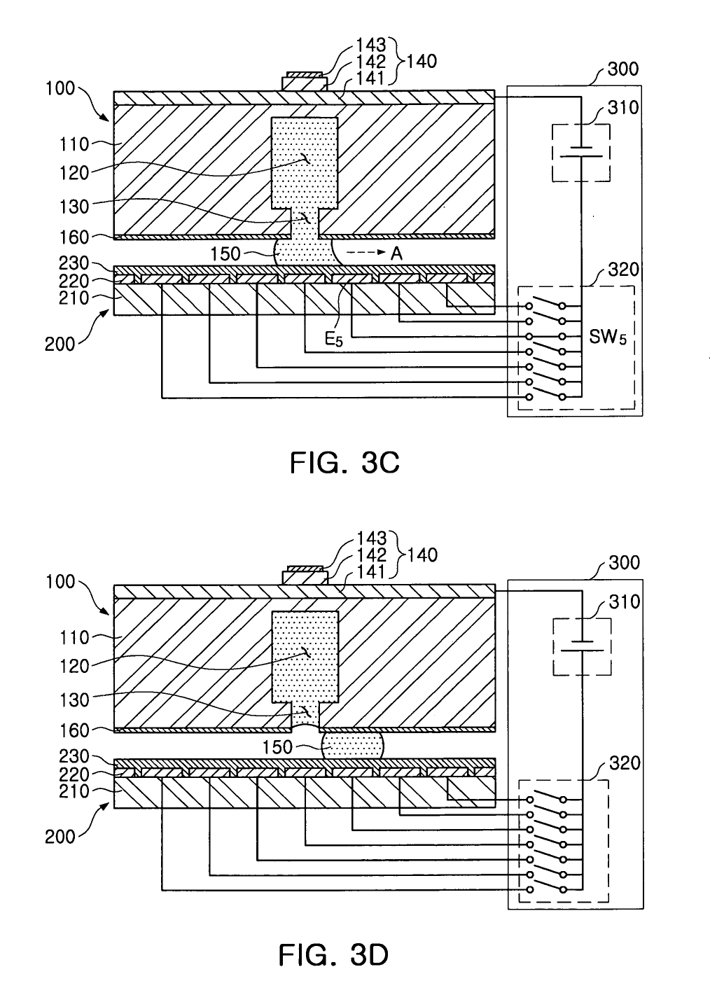

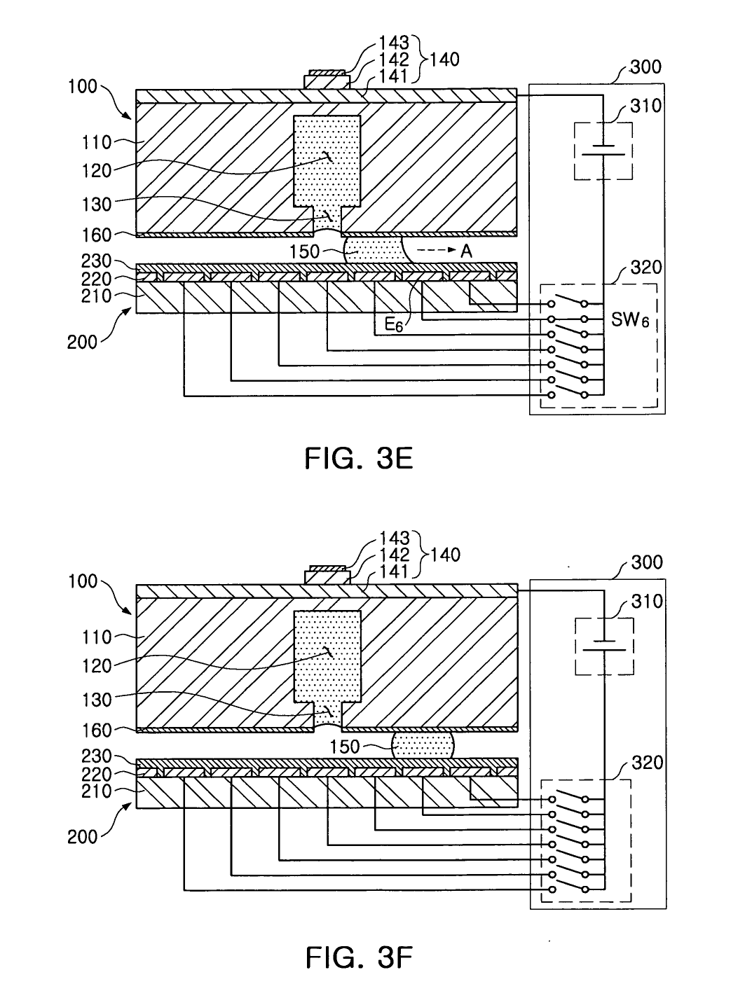

FIG. 1 is a schematic cross-sectional view illustrating an inkjet printer having an apparatus for cleaning an inkjet print head according to a first exemplary embodiment of the present invention. FIGS. 2A and 2B are views illustrating a cleaning principle according to an exemplary embodiment of the present invention. FIGS. 3A through 3F are views illustrating a method of cleaning the inkjet print head in the inkjet printer according to the first exemplary embodiment of the present invention.

With reference to FIG. 1, the inkjet printer according to the first exemplary embodiment of the invention includes an inkjet print head 100 having an ink flow path formed therein, a cleaning unit 200 for cleaning residual ink 150 remaining in the inkjet print head 100, and a power supply part 300 applying voltage to the inkjet print head 100 and the cleaning unit 200 during cleaning.

The inkjet print head 100 may include a board 110 and a piezoelectric actuator 140. The board 110 has therein an ink flow path formed of a pressure chamber 120, a nozzle 130 and the like. The piezoelectric actuator 140 is formed on the board 110 so as to correspond to the pressure chamber 120, and provides a driving force for ejecting ink drawn into the pressure chamber 120 through the nozzle 130.

The inkjet print head 100 may include a water-repellent layer 160 on a lower surface thereof in which the nozzle 130 is formed. The water-repellent layer 160 may be formed of a hydrophobic material such as polytetrafluroethylene (PTFE), perfluorinated silane, parylene or the like. The water-repellent layer 160 may be formed by spin coating, contact printing, e-beam evaporation or the like.

In the present embodiment, the pressure chamber 120 and the nozzle 130 form the ink flow path within the board 110, but they are the minimum indispensable elements necessary to explain the embodiment of the invention. The invention is not limited thereto. For example, the ink flow path may include an ink inlet through which to provide ink, a manifold transferring the ink drawn from the ink inlet to the pressure chamber 120, a restrictor formed between the pressure chamber 120 and the manifold to prevent the ink from flowing backwards, a damper formed between the pressure chamber 120 and the nozzle 130, and the like.

The piezoelectric actuator 140 may include a lower electrode 141 serving as a common electrode, a piezoelectric membrane 142 being deformed according to the application of voltage, and an upper electrode 143 serving as a driving electrode.

The lower electrode 141 may be formed on the entire surface of the board 110. The lower electrode 141 may be formed of a single conductive metallic material, but it may preferably be a metallic thin film formed of titanium (Ti) and platinum (Pt). The lower electrode 141 may serve not only as a common electrode, but also as a diffusion barrier layer preventing diffusion between the piezoelectric membrane 142 and the board 110. The piezoelectric membrane 142 is formed on the lower electrode 141 and disposed to be positioned above the pressure chamber 120. This piezoelectric membrane 142 may be formed of a piezoelectric material, preferably a Lead Zirconate Titanate (PZT) ceramic material. The upper electrode 143 is formed on the piezoelectric membrane 142. The upper electrode 143 may be formed of any one of Pt, Au, Ag, Ni, Ti and Cu.

In the present embodiment, ink droplets are ejected by a piezoelectric driving method using the piezoelectric actuator 140. However, the invention is not limited thereto. Ink droplets may be ejected in various manners such as a thermal driving method according to requisite conditions.

The cleaning unit 200 may include a cleaning plate 210 and an electrode part 220. At the time of the cleaning of the inkjet print head 100, the cleaning plate 210 is disposed under the inkjet print head 100 with a cleaning area interposed therebetween, and the electrode part 220 allows the residual ink 150 remaining at the end portion of the nozzle 130 to move outwardly of the cleaning plate 210.

Although not shown, the cleaning unit 200 may have a transfer unit causing the cleaning plate 210 to be disposed under the inkjet print head 100 with a gap corresponding to the cleaning area interposed therebetween, and a container receiving the residual ink 150 being moved outwardly of the cleaning plate 210.

The electrode part 220 may include a plurality of electrode cells E₁ to E₇ sequentially disposed on the cleaning plate 210. The plurality of electrode cells E₁ to E₇ may be formed by printing a plurality of electrode patterns on a printed circuit board.

A water-repellent layer 230 may be formed on an upper surface of the electrode part 220. The water-repellent layer 230 may be formed of a hydrophobic material such as polytetrafluroethylene (PTFE), perfluorinated silane, parylene or the like. The water-repellent layer 230 may be formed by spin coating, contact printing, e-beam evaporation or the like.

The power supply part 300 may include a power supply portion 310 and a switching portion 320. During cleaning, the power supply portion 310 applies voltage to the lower electrode 141 of the piezoelectric actuator 140 and the electrode part 220, and the switching portion 320 connects the power supply portion 310 to the plurality of electrode cells E₁ to E₇ of the electrode part 220 according to a direction A in which the residual ink 150 is moved.

The switching portion 320 may include a plurality of switches SW₁ to SW₇ making electrical connections between each of the plurality of electrode cells E₁ to E₇ and the power supply portion 310. As shown in FIG. 1, when a switch SW₅ is closed in the direction A in which the residual ink 150 is moved, an electrode cell E₅ is connected to the power supply portion 310. The switching portion 320 may be open or closed according to the controlling of a controlling part (not shown) in the direction A in which the residual ink 150 is moved.

Hereinafter, with reference to FIG. 2, the principle of cleaning an inkjet print head according to an exemplary embodiment of the invention will be described.

FIG. 2A illustrates a state in which a switch of a power supply part 410 is open such that no voltage is applied to an electrode 420 and ink 450. In this state, when the switch is closed, voltage is applied to the electrode 420 and the ink 450 as shown in FIG. 2B. At this time, a positive charge (+) is brought to the electrode 420 and a negative charge (−) is brought to the ink 450. Due to gravitational attraction between the charges of different polarities, the contact angle of the ink 450 is changed.

In this manner, in the case that the principle in which gravitational attraction is produced by applying voltage to the electrode 420 and the ink 450 is sequentially applied to each of the plurality of electrode cells, the residual ink remaining in the nozzle is moved. At this time, in the case that a water-repellent layer 430 is formed on the electrode 420, the movement of the ink 450 may be facilitated.

Hereinafter, with reference to FIG. 3, a method of cleaning an inkjet print head according to an exemplary embodiment of the invention will be described.

FIG. 3A illustrates a state in which the residual ink 150 remains at the nozzle 130 of the inkjet print head 100. When cleaning is started, as shown in FIG. 3B, the cleaning unit 200 is moved towards the nozzle 130 in a direction B in order that the cleaning unit 200 is disposed under the inkjet print head 100 with a gap corresponding to a cleaning area interposed therebetween. At this time, the residual ink 150 remaining in the nozzle 130 contacts the water-repellent layer 230 formed on the cleaning plate 210 and the water-repellent layer 160 formed on the lower surface of the inkjet print head 100 to be disposed around the nozzle 130. The residual ink 150 is disposed above an electrode cell E₄ (i.e., the upper part of the electrode cell E₄).

In the present embodiment, the direction in which the residual ink 150 is moved is set as a rightward direction (direction A). As shown in FIG. 3C, when the switch SW₅ is closed to electrically connect the lower electrode 141 and the electrode cell E₅, the residual ink 150 is charged with a negative charge through the ink contained in the pressure chamber 120 and the nozzle 130 and the electrode cell E₅ is charged with a positive charge. Accordingly, due to the gravitational attraction between the residual ink 150 and the electrode cell E₅, the lower portion of the residual ink 150 is deformed towards a direction of the electrode cell E₅.

At this time, when the switch SW₅ is open, the residual ink 150 is completely moved to the upper part of the electrode cell E₅ as shown in FIG. 3D.

Subsequently, as shown in FIG. 3E, when a switch SW₆ is closed to apply voltage to an electrode cell E₆, the electrode cell E₆ and the residual ink 150 are charged with positive and negative charges, respectively. Accordingly, due to the gravitational attraction between the residual ink 150 and the electrode cell E₆, the lower portion of the residual ink 150 is deformed towards a direction of the electrode cell E₆.

At this time, when the switch SW₆ is open, the residual ink 150 is completely moved to the upper part of the electrode cell E₆ as shown in FIG. 3F.

In this manner, the residual ink 150 may be moved outwardly of the cleaning plate 210 by sequentially switching the plurality of electrode cells E₁ to E₇ in the direction A in which the residual ink 150 is moved, the residual ink 150 being moved outwardly of the cleaning plate 210 is received in a container (not shown) prepared in the outside of the cleaning plate 210.

In the present embodiment, since the cleaning unit 200 performs cleaning including the removal of the residual ink 150 without contacting with the nozzle 130, the nozzle 130 may be prevented from being contaminated and damaged.

For example, in the case in which the inkjet printer according to this embodiment is used to form a conductive pattern on a printed circuit board, since ink has conductive properties, the cleaning of the nozzle may be facilitated. However, the invention is not limited thereto. Since ink used for general office appliances (OA) is also charged according to the movements of charges, there is no need to limit the types of ink in the present invention.

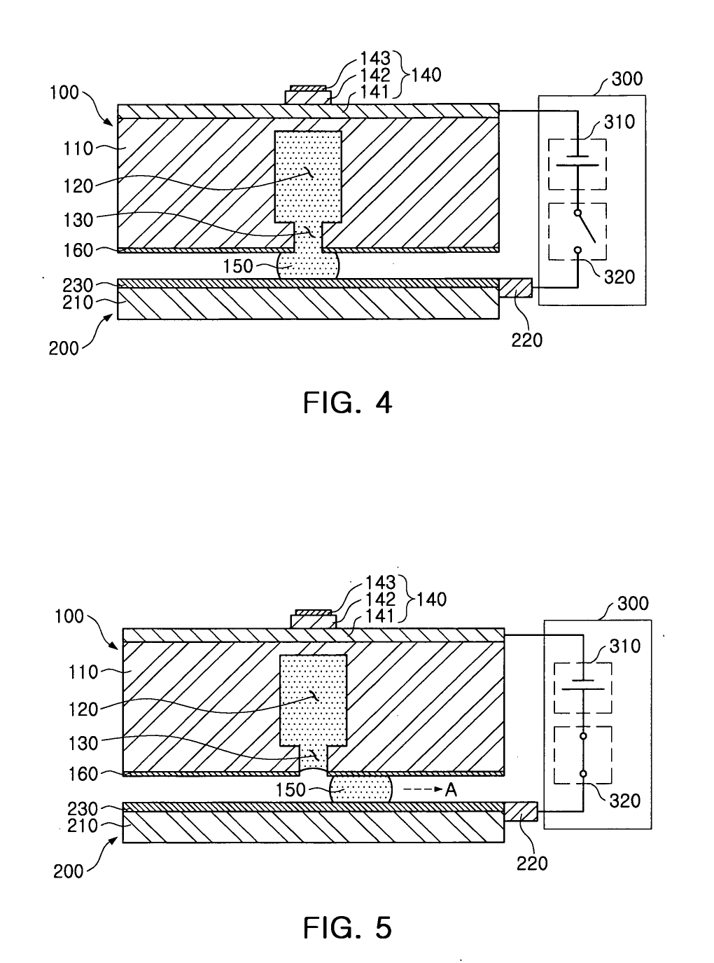

FIG. 4 is a schematic cross-sectional view illustrating an inkjet printer including an apparatus for cleaning an inkjet print head according to a second exemplary embodiment of the present invention. FIG. 5 is a view illustrating the movement of ink during cleaning in the inkjet printer according to the second exemplary embodiment of the present invention.

The inkjet printer according to the second exemplary embodiment illustrated in FIGS. 4 and 5 has a structure different from that of the inkjet printer according to the first exemplary embodiment illustrated in FIG. 1 in that it has an electrode part disposed on the outside of a cleaning plate. Hereinafter, a detailed description of different features will be provided for convenience of explanation.

As shown in FIGS. 4 and 5, the inkjet printer according to the second exemplary embodiment of the invention may include the inkjet print head 100, the cleaning unit 200 and the power supply part 300. The inkjet print head 100 includes the piezoelectric actuator 140 formed on the upper portion thereof, the pressure chamber 120 and the nozzle 130 formed in the ink flow path, and the water-repellent layer 160 formed on the lower surface thereof to be disposed around the nozzle 130. The cleaning unit 200 is provided to clean the residual ink 150 remaining in the nozzle of the inkjet print head 100. The power supply part 300 applies voltage to the inkjet print head 100 and the cleaning unit 200 during cleaning.

The cleaning unit 200 may include the cleaning plate 210 and the electrode part 220 disposed on the outside of the cleaning plate 210. The water-repellent layer 230 may be formed on the cleaning plate 210. At this time, the water-repellent layer 230 may also be formed on the electrode part 220.

When cleaning is started, the cleaning plate 210 is moved to have a gap corresponding to a cleaning area under the inkjet print head 100. As shown in FIG. 5, when the switching portion 320 is closed, the residual ink 150 is moved in the direction A due to the gravitational attraction between the electrode part 220 and the residual ink 150.

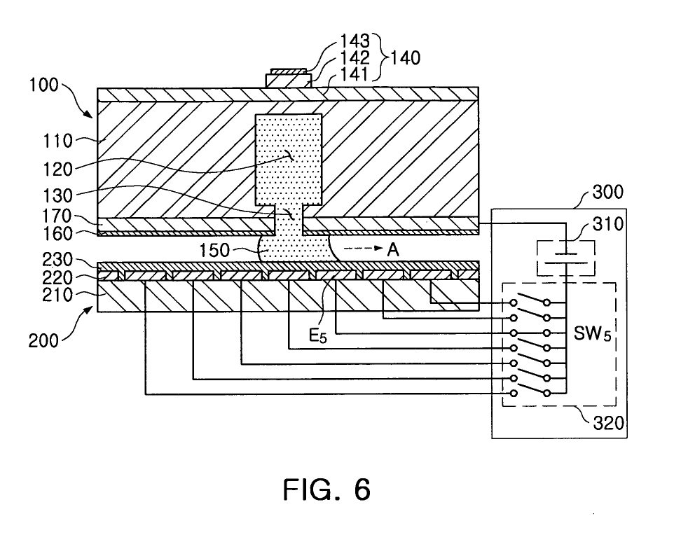

FIG. 6 is a schematic cross-sectional view illustrating an inkjet printer including an apparatus for cleaning an inkjet print head according to a third exemplary embodiment of the present invention.

The inkjet printer according to the third exemplary embodiment illustrated in FIG. 6 has a structure different from that of the inkjet printer according to the first exemplary embodiment illustrated in FIG. 1 in that an electrode applying voltage to ink is formed around a nozzle. Hereinafter, a detailed description of different features will be provided for convenience of explanation.

As shown in FIG. 6, the inkjet printer according to the third exemplary embodiment of the invention includes a second electrode 170 formed around the nozzle 130 in the lower portion of the inkjet print head 100. The water-repellent layer 160 may be formed on the lower surface of the second electrode 170.

When cleaning is started, the second electrode 170 and the electrode part 220 are electrically connected to each other such that the residual ink 150 is moved in the direction A due to the gravitational attraction between the residual ink 150 and the electrode part 220.

With reference to FIG. 6, when the switch SW₅ of the switching portion 320 is closed, the second electrode 170 is electrically connected to the electrode cell E₅. The residual ink 150 and the electrode cell E₅ are charged with negative and positive charges, respectively, and the lower portion of the residual ink 150 is deformed in the direction of the electrode cell E₅. In this manner, the electrode cells are electrically connected to the second electrode 170 in sequential order so that the residual ink 150 is moved outwardly of the cleaning plate 210.

The present invention is not limited to the above-described exemplary embodiments. For example, the exemplary embodiments of the present invention are described on the basis of the configurations of the electrode part, but the configurations of the electrode part are not particularly limited. An electrode part may be designed to have various forms so long as it can cause residual ink to be moved for the cleaning thereof without making contact with a nozzle. An electrode part may be designed to be disposed below a cleaning plate or to be installed within a cavity provided in a cleaning plate.

As set forth above, in an apparatus for cleaning an inkjet print head and an inkjet printer having the same according to exemplary embodiments of the invention, a nozzle of an inkjet print head is cleaned by a non-contact method so that the contamination of the nozzle and the damage of a water-repellent layer may be prevented. Accordingly, ink ejection characteristics can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for cleaning an inkjet print head, the apparatus comprising:
an electrode part spaced apart from an inkjet print head with a cleaning area interposed there between; and
a power supply part electrically connecting the inkjet print head to the electrode part.

2. The apparatus of claim 1, wherein the electrode part comprises a plurality of electrode cells sequentially disposed therein.

3. The apparatus of claim 2, wherein the power supply part electrically connects the inkjet print head to the plurality of electrode cells in sequential order along a path of residual ink remaining in the inkjet print head.

4. The apparatus of claim 1, wherein the electrode part is disposed outside the cleaning area.

5. The apparatus of claim 1, wherein the electrode part has a water-repellent layer disposed thereon.

6. The apparatus of claim 1, wherein the inkjet print head and the electrode part are electrically connected such that charges of different polarities are applied to ink of the inkjet print head and the electrode part, respectively.

7. The apparatus of claim 1, wherein the inkjet print head includes a piezoelectric actuator providing a driving force for ink ejection, and
the power supply part electrically connects a common electrode of the piezoelectric actuator to the electrode part.

8. The apparatus of claim 1, wherein the inkjet print head has a second electrode disposed around a nozzle, and
the power supply part electrically connects the second electrode to the electrode part.

9. An inkjet printer comprising:
an inkjet print head ejecting ink through a nozzle; and
a cleaning unit removing residual ink remaining at an end portion of the nozzle of the inkjet print head,
wherein the cleaning unit comprises:
an electrode part spaced apart from the inkjet print head with a cleaning area interposed therebetween; and
a power supply part electrically connecting the inkjet print head to the electrode part.

10. The inkjet printer of claim 9, wherein the electrode part comprises a plurality of electrode cells sequentially disposed therein.

11. The inkjet printer of claim 10, wherein the power supply part electrically connects the inkjet print head to the plurality of electrode cells in sequential order along a path of the residual ink.

12. The inkjet printer of claim 9, wherein the electrode part is disposed outside the cleaning area.

13. The inkjet printer of claim 9, wherein the electrode part has a water-repellent layer disposed thereon.

14. The inkjet printer of claim 9, wherein the inkjet print head has a water-repellent layer disposed on a lower surface thereof on which the nozzle is formed.

15. The inkjet printer of claim 9, wherein the inkjet print head and the electrode part are electrically connected such that charges of different polarities are applied to the residual ink and the electrode part, respectively.

16. The inkjet printer of claim 9, wherein the inkjet print head includes a piezoelectric actuator providing a driving force for ink ejection, and
the power supply part electrically connects a common electrode of the piezoelectric actuator to the electrode part.

17. The inkjet printer of claim 9, wherein the inkjet print head has a second electrode disposed around the nozzle, and
the power supply part electrically connects the second electrode to the electrode part.
